(19) United States
(12) Patent Application Publication
(10) Pub. No.: US 2005/0065951 A1
(43) Pub. Date: Mar. 24, 2005

(54) Visualization of commonalities in data from different sources

(76) Inventors: Kathleen Liston, Menlo Park, CA (US); Martin Fischer, Menlo Park, CA (US); John Kunz, Palo Alto, CA (US); Terry A. Winograd, Stanford, CA (US); Armando Fox, Palo Alto, CA (US); Bradley Earl Johanson, Palo Alto, CA (US)

Correspondence Address: LUMEN INTELLECTUAL PROPERTY SERVICES, INC., 2345 YALE STREET, 2ND FLOOR, PALO ALTO, CA, 94306, US

(21) Appl. No.: 10/651,763

(22) Filed: Aug. 29, 2003

Related U.S. Application Data
(60) Provisional application No. 60/407,240, filed on Aug. 30, 2002.

(51) Int. Cl. G06F 17/00; G06F 17/30; G06F 9/44

(52) U.S. Cl. 707/101; 707/10; 707/201; 717/101

(57) ABSTRACT

In a highly integrated computing environment having a collection of linked software and hardware that allows one or more users to readily structure, display and manipulate various information used to design and implement a large project, two classes of new software tools, viewers and controllers, are disclosed herein to support the construction industry and to enhance the simultaneous visualization of complex information sets on two or more interactive electronic displays. Information Viewers display table, tree, and document views of information representing different viewpoints and approaches of the same project. The Synchronizing Controller links the various, distributed applications to a common date, time, event, and the likes. The Information Viewers are also controllers that extract related data from different applications. The Universal Controller manages and organizes data and applications in the integrated computing environment. A project database containing only data shared among the multiple distributed applications is included.

### CROSS-REFERENCE TO RELATED APPLICATION

This application claims the benefit of a provisional patent application No. 60/407,240, filed Aug. 30, 2002, of which the entire content and appendices, including computer source code, are incorporated herein by reference.

### STATEMENT REGARDING FEDERALLY SPONSORED RESEARCH OR DEVELOPMENT

The present invention was supported in part by grant number 0075672 from the National Science Foundation (NSF). The U.S. Government may have certain rights in the invention.

### COPYRIGHT NOTICE AND AUTHORIZATION

A portion of the disclosure of this patent document contains material which is subject to copyright protection. The copyright owner has no objection to the facsimile reproduction by any one of the patent document or the patent disclosure, as it appears in the U.S. Patent and Trademark Office patent file or records, but otherwise reserves all rights whatsoever.

### BACKGROUND OF THE INVENTION

1. Field of the Invention

The present invention relates generally to data management. More particularly, the present invention relates to integrating and managing diverse information from different sources for simultaneous visualization thereof in a highly integrated interactive environment.

2. Description of the Related Art

Engineering, manufacturing, and construction management involves integrating information from a wide variety of different sources, for example, project schedules, computer-assisted drawing (CAD) models, spreadsheets, work orders, contractual documents, charts, lists, and the like. The integration of such diverse information could be written down on paper and/or entered into a computer and processed by a computer program. These documents are tightly related, representing different views and approaches of the same project. Effective planning and decision-making for the project requires analyzing critical relationships among these views and approaches. Traditionally, they end up on paper, which is then pinned to walls and spread out on tables for comparison. This method is time consuming and cumbersome in finding something as simple as a common date or part in the various documents.

An advanced way of presenting and analyzing data of a wide variety of different sources is to display the data electronically, for example, on computer screens or electronic walls. These electronic display means provide a better and more efficient way of presenting the different forms of data for analysis such as during a project meeting as shown in FIG. 1A. However, this method is costly and inefficient and requires the presenter to be familiar with a variety of different applications commonly utilized during the design and planning process of the project. Whether a single laptop or a network of computers is used, these different applications do not interrelate or interoperate, i.e., they function independently from one another. On the other hand, each of these applications or programs models a subset of the overall project's context. It is therefore important to identify the existing interrelations between these sub-models of the different applications, especially for the interdisciplinary tasks discussed in project meetings.

Currently, these applications typically adopt the well-known Model-View-Controller (MVC) application architecture. That is, each application has a graphical user interface (GUI) consisting of a MVC triad. FIG. 1B shows a computer screen 100 displaying a plurality of GUI's of different applications 110, 120, 130. Model 111 represents data and rules, e.g., access and modification, specific to application 110. Model 111 notifies view 112 when it changes and enables view 112 to query model 111 about its state. Model 111 also enables controller 113 to access application functionality. View 112 defines how model 111 is shown and forwards user feedback to controller 113. Controller 113 defines application behavior and handles user interaction, i.e., it interprets and maps user feedback into actions to be performed by model 111. Similarly, application 120 consists of model 121, views 122₁ . . . 122ₖ, and controller 123 and application 130 consists of model 131, view 132, and controller 133. Within each application domain, there can be more than one views and/or more than one controllers, each for a particular functionality.

Unfortunately, the current MVC architecture is unable to identify the existing interrelations between sub-models of different applications. This leads to redundancies and inconsistencies with respect to project data and management, and therefore is counterproductive to the designing, planning, and decision-making process.

Accordingly, there is a need for new systems and methods that can generate dynamic multiple views of project data consistent across application domains as well as platforms and physical boundaries. Furthermore, there is a need for a centralized, easy to use GUI that controls multiple applications running on different computers such that related project information from various applications can be simultaneously visualized on multiple displays.

### SUMMARY OF THE INVENTION

The present invention provides computer-implemented systems, methods and tools for dynamically synchronizing and coordinating views and controls of diverse, multidisciplinary project data from a wide variety of sources such as applications and databases. The views and controls can be simultaneously visualized on multiple displays in a highly integrated interactive environment, across application domains as well as platforms and physical boundaries. A primary goal of the present invention is to provide computerized enhancement that would make a multi-display or multi-view interactive environment functional and productive. To achieve this goal, we focus on the following areas:
highlighting related sets of data within and across views and applications,
managing views of project models and comparative states of a project model, and
exchanging and synchronizing sets of project model information to support visualization.

The preferred embodiment disclosed herein is an iRoom-based system referred to as the CIFE iRoom developed by the Stanford Center for Integrated Facility Engineering. iRoom is an integrated interactive workspace developed by the Stanford University Computer Science Department. The CIFE iRoom can be characterized as a collection of linked software and hardware that allows one or more users to readily structure, display and manipulate various information used to design and implement a large project. As one skilled in the art can appreciate, these software and hardware can be readily implemented for use in other suitable interactive systems and environments. The CIFE iRoom includes new viewers and controllers that are particularly useful to the construction industry. Notwithstanding application domains and physical boundaries, the viewers display on separate electronic white broads 4D models, tables, trees, and documents representing different viewpoints and approaches of the same project. The viewers can also be characterized as controllers that extract related data from different applications. A synchronizing means such as a time controller links the various, distributed applications to a shared element, variable, and/or feature, e.g., a common date, time, part, or event. A universal controller such as a room controller manages and organizes the shared data and the various, distributed applications in the CIFE iRoom.

The CIFE iRoom viewers and controllers effectively separate the visual user interfaces from their respective applications, thereby allowing these user interfaces and hence the data to be independently displayed on systems and/or devices different than the systems and/or devices running the applications. The separation of control from data and application substantially enhances the simultaneous visualization of diverse information and significantly improves multidisciplinary data and ultimately project management.

The present invention further provides a project database containing only data shared among the multiple distributed applications. The project database is very efficient to run because it moves only small amounts of data.

### BRIEF DESCRIPTION OF THE DRAWINGS

FIG. 1A illustrates a prior art approach in designing, planning, scheduling, and managing a multidiscipline project.

FIG. 1B schematically shows a computer screen with multiple applications each of which has its own MVC components.

FIG. 2 illustrates the CIFE iRoom approach.

FIG. 3A shows the CIFE iRoom architecture.

FIG. 3B shows the CIFE iRoom framework.

FIG. 4 shows an embodiment of the CIFE iRoom framework.

FIG. 5A is a top level schematic of the CIFE iRoom project database.

FIG. 5B shows an exemplary structure of project database elements.

FIG. 6 is an implementation of the CIFE iRoom configuration.

FIG. 7 is a screen snapshot showing an exemplary room controller for the CIFE iRoom.

FIG. 8 is a screen snapshot of a modeling application showing a portion of a 4D model and an exemplary time controller.

FIG. 9 is a screen snapshot of another exemplary time controller.

FIG. 10 is a screen snapshot showing exemplary data viewers.

FIG. 11 is a screen snapshot of a project application showing a portion of a chart view of a project.

FIG. 12 shows multiple views of two different scenarios. The views are dynamically and automatically updated following any changes.

FIG. 13 is a screen snapshot showing dialogs to relate XML data file objects.

FIG. 14 is a screen snapshot showing dialog windows with additional object information.

FIG. 15 is a screen snapshot showing highlighting of structural elements in ADT while working with the Relation Tool.

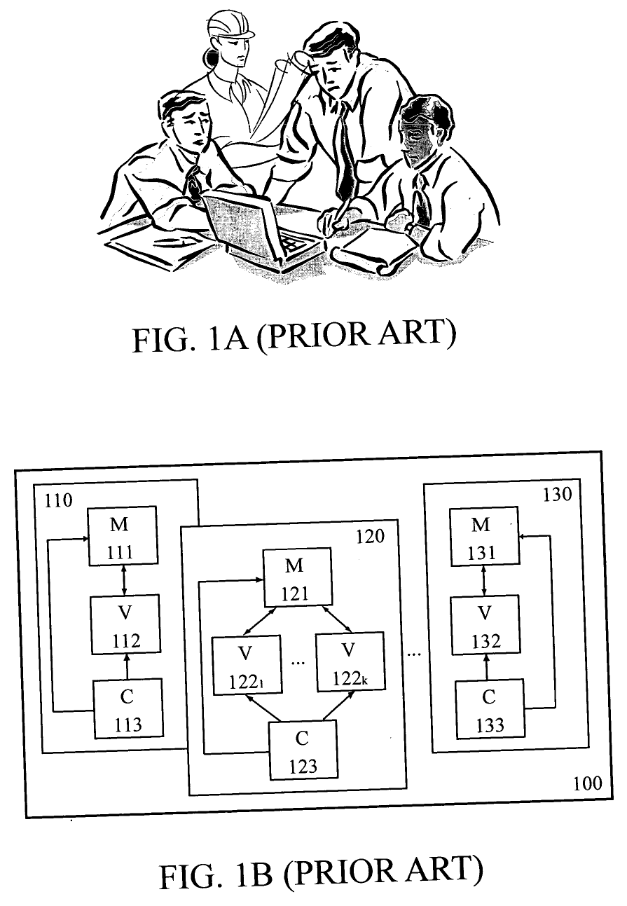

### DETAILED DESCRIPTION OF THE PREFERRED EMBODIMENTS

To achieve interactivity, two prerequisites have must be fulfilled. First, a common data model is needed for the distributed project data. This model should provide flexibility towards different project scopes that are defined by the data elements contributed by the various applications. Such a general project data model should allow identifying and addressing specific data objects in the iRoom environment. Second, a general messaging framework on top of the project data model is necessary to provide cross application functionalities. This messaging framework should be flexible towards later functional extensions.

Consider the following problems one may encounter in developing such a general project data model:
The project data are distributed in different applications. These applications, used in the miscellaneous disciplines, have separate data models with their individual data structures.
The same data elements can appear in more than one application. Regarding their identification, this means that the project data model must be flexible towards redundancy.
In the data structures of the different applications, these semantically identical data elements are named differently and broken up into different hierarchies or levels of detail.

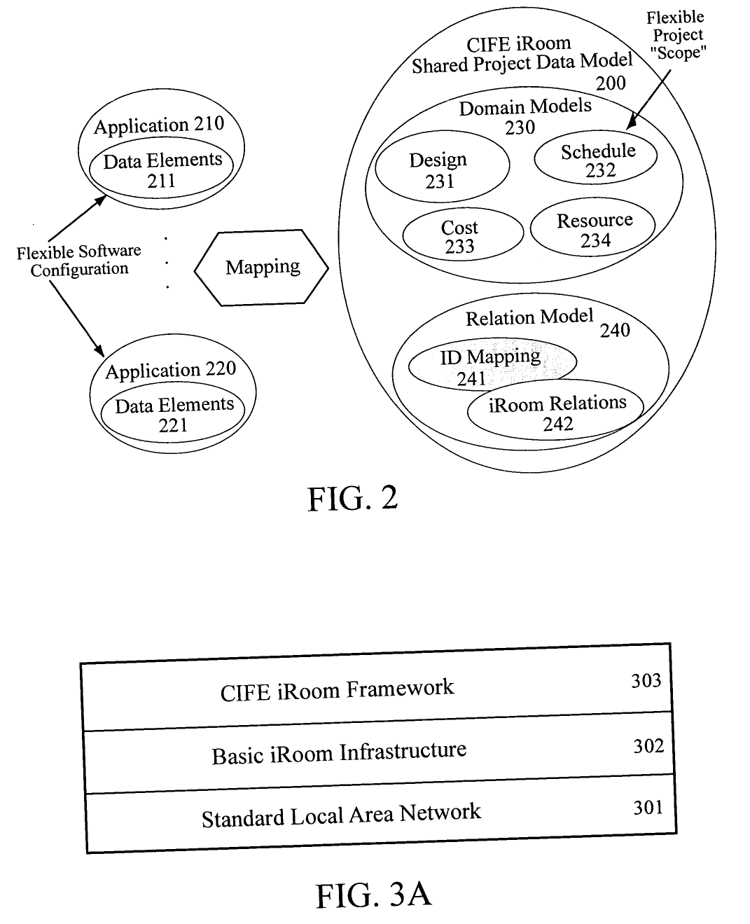

Our approach to solving these problems is illustrated in FIG. 2. We map the data elements, stored in the data structures of the various applications, to a Shared Project Data Model 200 in a bidirectional fashion. As an example, application 210 might be MS Projects and data elements 211 might be tasks thereof. Application 220 might be Autodesk® ADT and data elements 221 might be ADT objects such as volume, surface area, etc. Further, we model the relationships necessary to describe this mapping separately from the data themselves. For example, the Shared Project Data Model 200 includes Domain Models 230 and Relation Model 240. The Domain Models 230 might include project models such as Design 231, Schedule 232, Cost 233, and Resource 234. The Design model 231 might include information related to building components and quantity thereof. The Schedule model 232 might include construction activity. The Cost model 233 might include information related to item costs. The Resource model 234 might include information related to resources. The Relation Model 240 might include ID Mapping 241 for mapping application objects to project model objects and iRoom Relations 242 for mapping project model objects to project model objects.

This innovative Shared Project Data Model approach provides flexibility towards different project scopes that are defined by the applications and the data they provide to the miscellaneous project domains. The CIFE iRoom Shared Project Data Model approach is realized in a suite of software tools that enables separate applications to generate active views that highlight or compare common items/data/elements across application domains and data sets. In the CIFE iRoom, data can be dynamically collected and reformatted across applications, making it easier to construct and compare different design and production scenarios. Novel views and visualizations allow for comparing scenarios, enabling “what if” discussions far beyond what are currently possible. As such, it is easier to be sure that information shared at meetings is up-to-date, and to capture the results of decision-making processes by immediately applying the specified changes to the multiple models to which they apply. The CIFE iRoom advantageously eliminates delays and ensures that everyone in the meeting understands the context and impact of decisions being made.

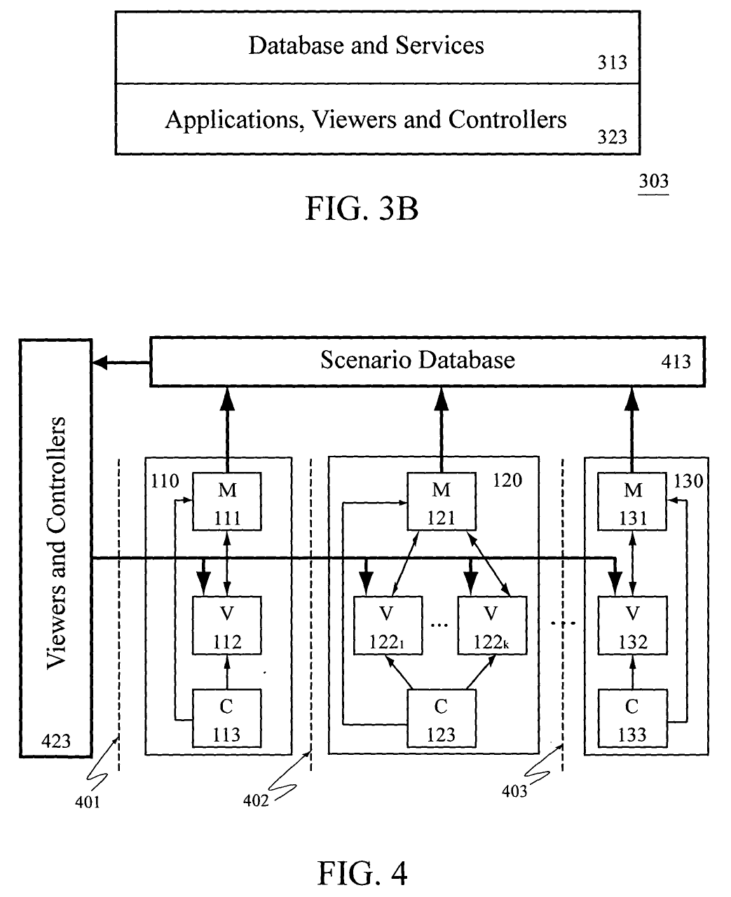

As shown in FIG. 3A, the CIFE iRoom 303 is built on top of the iRoom infrastructure 302, which in turn, is built on a standard, networked collection of computers and peripheral devices, referred to as the iRoom computing infrastructure 301. In an embodiment, the iRoom computing infrastructure 301 comprises four computers with Windows®-based operating system and the Java runtime. These computers are networked using the TCP/IP protocol, wired or wireless. There can be more or fewer computers as needed.

The iRoom infrastructure 302 comprises iRoom hardware and iRoom software. As discussed before, an iRoom is a room-based interactive workspace. Most iRooms include large-format displays as electronic walls to facilitate shared views of applications and information. The iRoom infrastructure implements linking and coordination among applications running in the iRoom in a way that supports legacy applications as well as custom-built tools and viewers. In an embodiment, the iRoom hardware includes three SMART boards with their touch panels, plus a wireless mouse and keyboard. Three of the computers drive the SMART boards; the fourth one is connected to the wireless mouse and keyboard and acts as the iRoom server machine. There can be more or fewer SMART boards as needed. The iRoom software provides a general coordination mechanism for the various, distributed application to post and/or retrieve messages or events. The iRoom software also provides a general mechanism for passing Windows commands between machines and supports browsing multiple events. The iRoom software further includes a program that enables all of the machines in the iRoom to be controlled with a common mouse and a keyboard. For more detailed information on the basic iRoom infrastructure, readers are referred to B. Johanson et al. “The Interactive Workspaces Project: Experiences with Ubiquitous Computing Rooms,” IEEE Pervasive Computing Magazine 1(2), April-June 2002, which is incorporated herein by reference.

Referring to FIGS. 3A and 3B, the CIFE iRoom framework 303 includes two layers: database and services layer 313 and applications, viewers, and controllers layer 323. These two layers encompass the suite of programs that define the CIFE iRoom. The database and services layer 313 includes those components that manage the project scenarios. It also includes a server-based room controller for managing applications and data in the iRoom. This layer includes the following primary components:

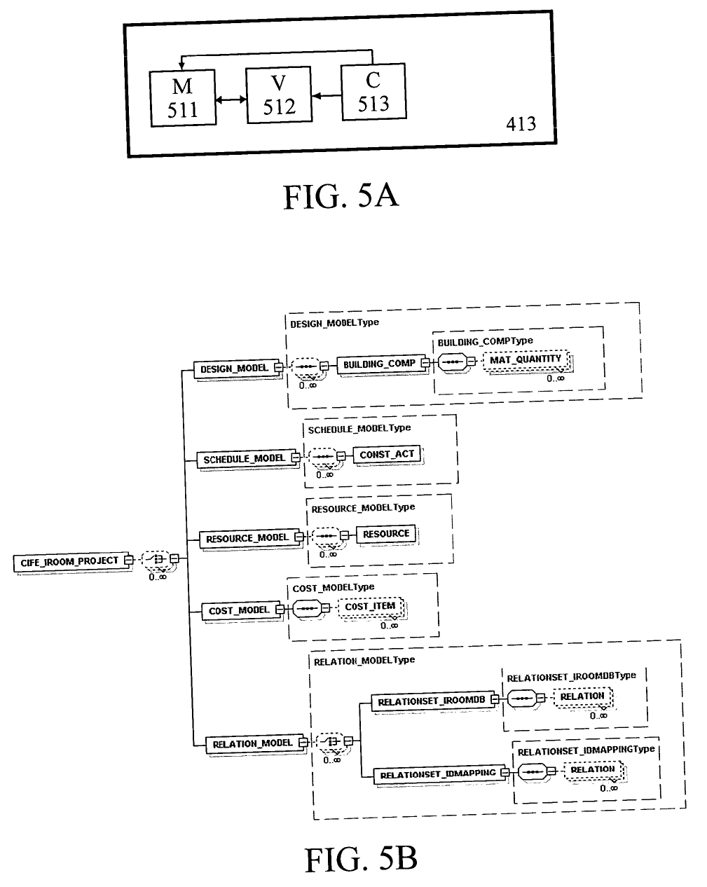

Scenario database 413—There is no centralized database that represents the entire project model in the CIFE iRoom; the project model is represented by a collection of data that are stored in many different forms. There is, however, a database of scenarios. In an exemplary embodiment, scenario database 413 is a commercial XML database, for example, by eXcelon, which includes a web-based set of tools for managing it. The CIFE iRoom users generate these scenarios from the native formats of a variety of programs, allowing users to make modifications in whatever program is most natural. Different scenarios can reside in the database simultaneously, making it possible to compare alternate states of the project model. A top level of an exemplary CIFE iRoom scenario database 413 having its own MVC 511, 512, 513, respectively, is shown in FIG. 5A. An exemplary structure of database elements is shown in FIG. 5B. FIGS. 5A and 5B will be discussed in a later section in conjunction with the CIFE iRoom XT data repository.

Import-export utility—a utility program for translating between the database and native file formats for the construction of scenarios. The import-export utility is a utility program that provides the user with an interface to import in one file format, e.g., a 4D file (.VFE), and convert it into an XML file, which can then be stored to the XML database and be used to generate the desired data views.

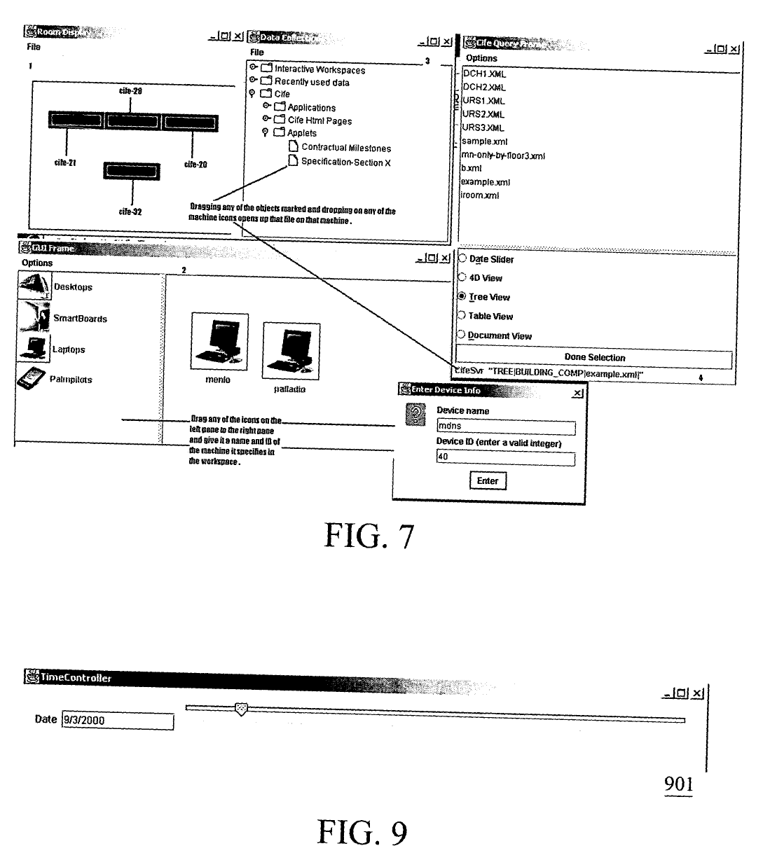

Universal controller—a special tool that provides a graphical interface for managing applications and data in the CIFE iRoom and provides a graphical view of the iRoom layout. This tool is a Java applet, built on the web-based controls provided in all iRooms for managing applications and events. As a result, its functionality can also be presented as customized web pages. Users can drag and drop applications and data around the room using the universal controller. In an embodiment, the universal controller is referred to as the room controller. The room controller will be further discussed later in details with reference to FIG. 7.

The CIFE applications, viewers and controllers layer 323 allows users to display, highlight and manipulate information about a scenario. Communication between these components involves sending and receiving events such as “set date” or “highlight activity.” This layer includes the following key components:

Applications. These include customized versions of CPT's 4D Modeler, Microsoft Project, and Excel. These applications are commonly used today as part of the construction management process. The customized versions thereof have been augmented to make them send and receive events. An exemplary screen snapshot of the MS Project is shown in FIG. 11.

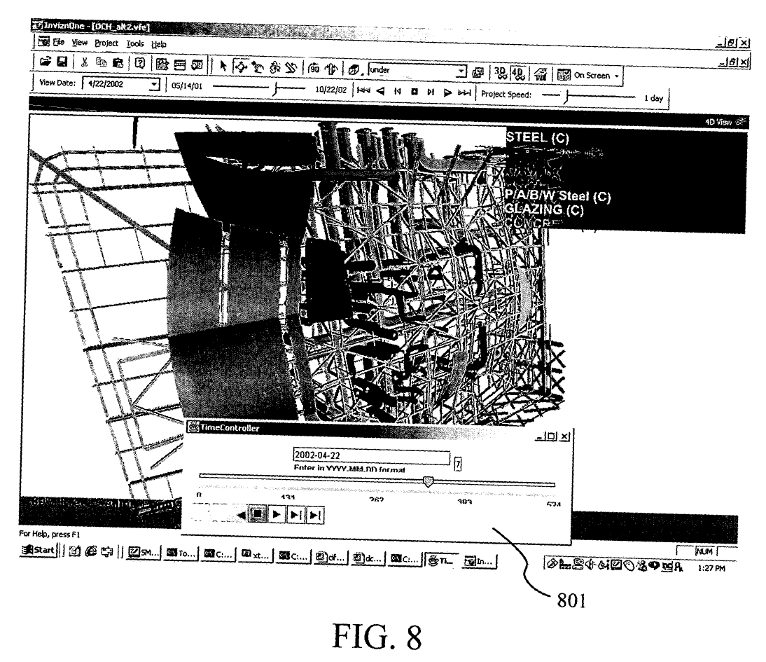

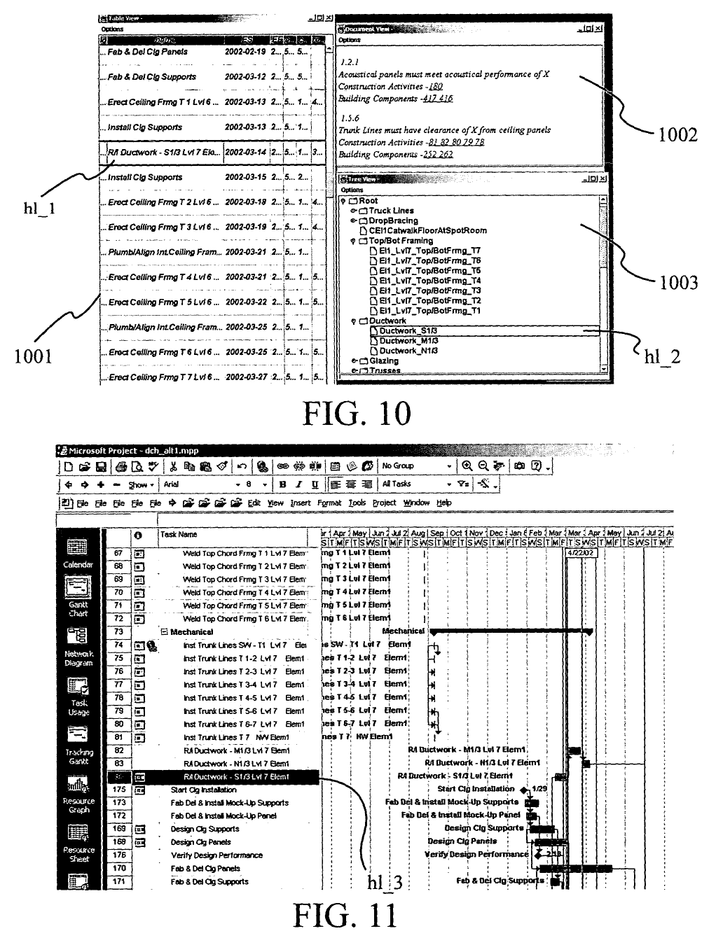

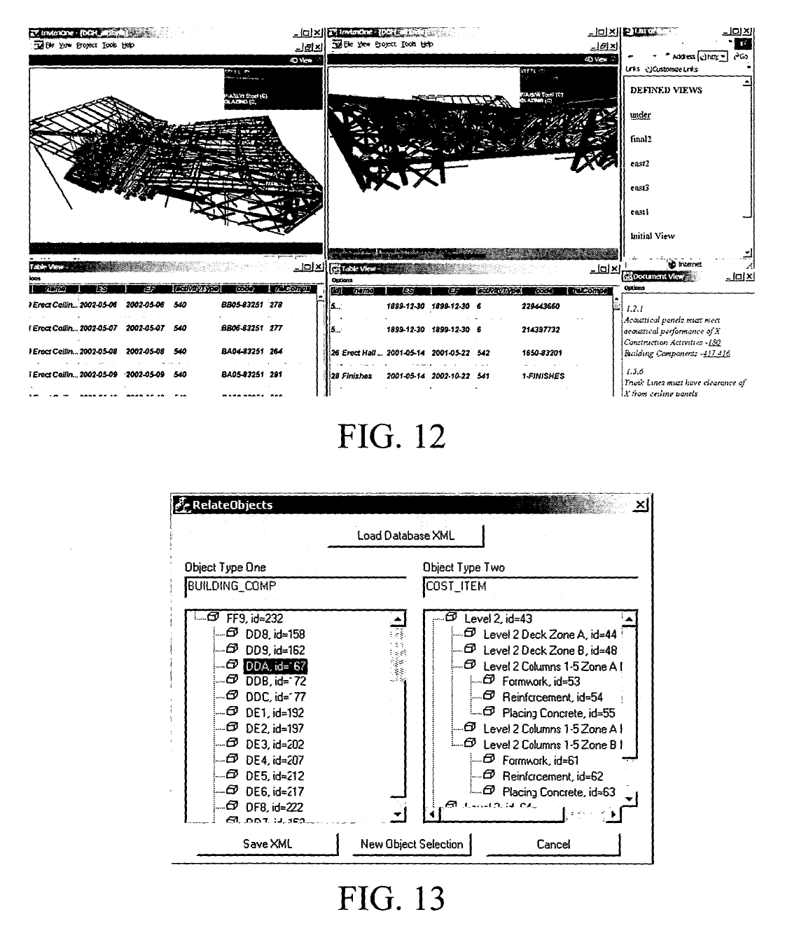

Viewers. The CIFE iRoom includes three custom-made Data Viewers for displaying and manipulating table, tree and document views of information stored in the scenario database and acting as controllers for simultaneous highlighting. Users can click on an activity or part to highlight the same or related parts in all the applications and viewers. Exemplary screen snapshots of the Data Viewers are shown in FIG. 10 and the 4D Model Viewer in FIGS. 8 and 12.

Controllers. A synchronizing means such as a time controller links the various, distributed applications to a shared element, variable, and/or feature, e.g., a common date, time, part, or event. The Time Controller is a custom synchronization controller that can link all applications to a common date. The Data Viewers are also controllers. Controllers send events to applications that listen for events. Clicking on a piece of information in one of these viewers sends an event that highlights the same information, or in some cases, related information, in all other views. The Data Viewers provide simplified views of the scenario data. Similarly, the Time Controller can be used to synchronize the views provided by all applications to the same date. Exemplary screen snapshots of the Time Controllers are shown in FIGS. 8 and 9.

FIG. 4 shows a more detailed example of the CIFE iRoom scenario database 413 and the CIFE iRoom viewers and controllers 423, along with a plurality of different applications 110, 120, 130, each have MVC logical components as discussed before. What is different here is that applications 110, 120, 130 are distributed in the CIFE iRoom across physical boundaries 401, 402, 403. The different applications or software programs 110, 120, . . . 130 are arranged in a heterogeneous manner instead of a hierarchical manner. In most applications, these different applications do not share a similar software, data schema, or hardware environment. In the present invention, the different applications could be any type of software application, working on any type of computer platform, and on any type of operating system. An example of a current application would be a software application like Microsoft® Project in which the Microsoft® Project would have specific data related to a project that a person is working on and a control to control the graphical user interface to display the data on a computer screen or display.

Furthermore, the present invention is not limited to visualizing related data in software applications, since the visualization could also be accomplished on physical models, demonstration models, devices or the like. The key idea is that the method of the present invention controls and displays the visualization of related data from a wide variety of sources in a simultaneous fashion. In one embodiment, the present invention utilizes multiple displays such as electronic walls or smart-boards, personal or laptop computer displays, personal data assistant displays, or specialized other displays.

The CIFE iRoom viewers and controllers 423 enables an additional control over the visualization of different application views 112, 122₁, . . . 122ₖ, and 132, which is separate and independent from their respective application control 113, 123, and 133. In other words, the CIFE iRoom viewers and controllers 423 controls each view in each application to coordinate and synchronize the visualization of the different data thereof. The CIFE iRoom viewers and controllers 423 provides the functionality of displaying a commonality in the data or, for instance, of highlighting in each of the application views 112, 122₁ . . . 122ₖ, and 132 the related aspects or common data that the applications 110, 120, . . . 130 share for a particular project. On the other hand, the CIFE iRoom viewers and controllers 423 is not limited to highlighting related information or data in an application, since there could be different ways and means to visualize information or data in an application, which are well known in the art.

The CIFE iRoom viewers and controllers 423 could include a time-controller in which time events are synchronized and simultaneously displayed/viewed in each application, a date-controller in which date events are simultaneously displayed/viewed in each application, and/or a class-controller which certain predefined classes (e.g. decisions steps, model aspects, manufacturing steps, part numbers, or the like) are simultaneously displayed/viewed in each application. In a particular embodiment of the present invention, listeners (not shown) are provided to interface application views 112, 122₁, . . . 122ₖ, and 132 and the CIFE iRoom viewers and controllers 423.

The related data or commonalities in data that are controlled by the CIFE iRoom viewers and controllers 423 are organized in the CIFE iRoom scenario database 413. A human or computer agent user could select from database 413 which aspects or relations he/she/it would like to visualize across the different data in the different sources of applications or devices. The data in database 413 operates at a more global level compared to the data in each application, and could be related to time events, date events, decisions steps, classes, physical objects, and the like. In a particular embodiment, Application Programming Interfaces (APIs) are provided to interface the application models 111, 121, and 131 and database 413.

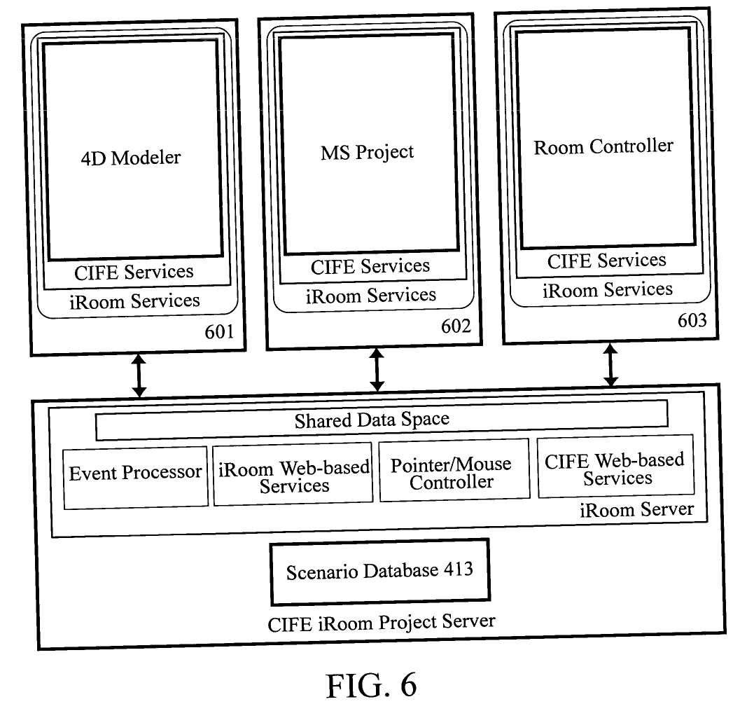

FIG. 6 shows an exemplary CIFE iRoom configuration with three large SMART® boards 601, 602, and 603. Each board acts as a large Windows® desktop that can be easily viewed by a group of people. The SMART boards are simply projection surfaces; the projectors are in the center of the room. While front projection inevitably causes shadows, this configuration is more flexible and less expensive than rear-projected SMART boards. Each SMART board has a touch panel, which substitutes for a mouse. Touch input allows a user, or a group of users, to stand at the screen and interact directly with it. To more conveniently treat the three displays as a continuous workspace, there is a wireless mouse and keyboard that can operate on any of the three desktops. This utility is provided by an iRoom software application as discussed before. One skilled in the art would appreciate that this particular configuration is simply an example and that similar devices can appropriately substitute the particular devices describe here. For example, suitable interactive display means can replace the SMART boards. Other wired and/or wireless pointing/input devices can replace the wireless mouse and keyboard, etc.

Users can run applications such as Microsoft Project®, Excel®, or Common Point® Technologies' (CPT) 4D Modeler to display and manipulate project data, just as they would on a personal desktop. This makes it easier to view the most up-to-date and relevant information, to view a variety of information simultaneously, and to easily make changes during a meeting. FIGS. 7-12 are screen snapshots taken from the multiple displays showing examples of using the CIFE iRoom for exploring and comparing scenarios.

Using the CIFE iRoom begins with the Room Controller, a Java applet that is used to direct applications to the different screens in the room. It is also used to manage machines and to select content from the database via Query Frames. The Room Controller is launched from a web page. FIG. 7 shows the Room Controller, which has four separate frames. Frame 1 is a schematic of the iRoom machines; the three SMART board machines in a horizontal row, plus the server machine (cife-32). Frame 2 provides a way to add other machines to the iRoom configuration, such as laptops brought by meeting attendees. The figure shows a dialog box generated by a request to add a machine. The user must provide a name and ID for the iRoom infrastructure. Frame 3 provides a list of applications and data. These can be dragged onto one of the gray boxes representing the machines to display them. For example, dragging a URL will launch a web browser to display it. Frame 4 is a Query Frame showing a list of scenario files that are stored in the scenario database. The applications listed below them can read them. First, the user selects an application using the radio buttons and then selects an XML data file corresponding to the desired scenario. Clicking “Done Selection” creates a text string (shown at the bottom of the frame) that can be dragged onto one of the gray boxes (machines) in Frame 1. This launches a Tree View of the selected data. If necessary, a dialog box is provided for the user to select which aspects of the data should be included in the view. Multiple scenarios can be viewed simultaneously, as will be shown and described hereinafter. Exemplary room controller code is provided below:

```
- <roomcontroller>
  <color name=“red” red=“255” green=“0” blue=“0” />
  <color name=“teal” red=“153” green=“204” blue=“204” />
  <color name=“gray” red=“128” green=“128” blue=“128” />
  <color name=“lightblue” red=“30” green=“255” blue=“255” />
  <color name=“black” red=“0” green=“0” blue=“0” />
  <color name=“yellow” red=“255” green=“255” blue=“0” />
  <color name=“white” red=“255” green=“255” blue=“255” />
  <stroke name=“s12” width=“1.2” />
  <stroke name=“s30” width=“3.0” />
  <stroke name=“s35” width=“4.0” />
  <stroke name=“s42” width=“4.2” />
- <window x=“10” y=“10” width=“320” height=“300” title=“Room Display” visible=“yes”
name=“WINDOW_roomdisplay”>
- <eventhandler>
  <onclose event=“#window|WINDOW_tree|close;#window|WINDOW_common|close;#system|exit” />
  <onminimize event=“#window|WINDOW_tree|minimize;#window|WINDOW_common|minimize” />
  <onrestore event=“#window|WINDOW_tree|restore;#window|WINDOW_common|restore” />
  </eventhandler>
- <menubar>
- <menu text=“File”>
- <!-- <item text=“Show light controls” event=“#system|print|Light controls not implemented yet.”/> <separator/>
<menu text=“Send command to...”> <item text=“Smartboard 1” event=“#multibrowse|sb1|prompt”/> <item
text=“Smartboard 2” event=“#multibrowse|sb2|prompt”/> <item text=“Smartboard 3”
event=“#multibrowse|sb3|prompt”/> <item text=“Table” event=“#multibrowse|table|prompt”/> <item text=“Front”
event=“#multibrowse|front|prompt”/> </menu> <separator/> -->
  <item text=“Get interface (debugging)” event=“#interface|[prompt|text|Enter interface:|Enter interface]” />
  <item text=“Exit” event=“#system|exit” />
  </menu>
  </menubar>
- <content layout=“absolute”>
- <graphicspanel x=“0” y=“0” width=“300” height=“250” name=“roommap” bgcolor=“teal”>
- <background>
- <render shape=“rect” x=“14” y=“37” width=“286” height=“208” name=“RENDER_roomoutline”>
  <outline color=“black” stroke=“s12” />
  </render>
- <render shape=“rect” x=“120” y=“150” width=“75” height=“20” name=“RENDER_c0”>
  <fill color=“gray” />
  <outline color=“black” stroke=“s35” />
  </render>
- <render shape=“rect” x=“40” y=“80” width=“75” height=“20” name=“RENDER_c1”>
  <fill color=“gray” />
  <outline color=“black” stroke=“s35” />
  </render>
- <render shape=“rect” x=“120” y=“80” width=“75” height=“20” name=“RENDER_c2”>
  <fill color=“gray” />
  <outline color=“black” stroke=“s35” />
  </render>
- <render shape=“rect” x=“200” y=“80” width=“75” height=“20” name=“RENDER_c3”>
  <fill color=“gray” />
  <outline color=“black” stroke=“s35” />
  </render>
  </background>
- <panel x=“120” y=“150” width=“75” height=“20” name=“CifeSvr” tooltip=“CifeSvr”>
- <eventhandler>
  <ondrag event=“#system|print|c0: Drag started.” />
  <ondrop event=“#multibrowse|c0|view|$DATA$” id=“1” />
  </eventhandler>
- <popupmenu>
  <item text=“Execute command...” event=“#multibrowse|c0|prompt” />
  <separator />
  <item text=“Cancel” />
  </popupmenu>
  </panel>
- <panel x=“40” y=“80” width=“75” height=“20” name=“Cife2” deviceid=“3” tooltip=“Cife 28”>
- <eventhandler>
  <ondrag event=“#system|print|c1: Drag started.” />
  <ondrop event=“#multibrowse|c1|view|$DATA$” id=“3” />
  </eventhandler>
- <popupmenu>
  <item text=“Execute command...” event=“#multibrowse|c1|prompt” />
  <separator />
  <item text=“Cancel” />
  </popupmenu>
  </panel>
- <panel x=“120” y=“80” width=“75” height=“20” name=“Cife3” deviceid=“4” tooltip=“Cife 20”>
- <eventhandler>
  <ondrag event=“#system|print|c2: Drag started.” />
  <ondrop event=“#multibrowse|c2|view|$DATA$” id=“4” />
  </eventhandler>
- <popupmenu>
  <item text=“Execute command...” event=“#multibrowse|c2|prompt” />
  <separator />
  <item text=“Cancel” />
  </popupmenu>
  </panel>
- <panel x=“200” y=“80” width=“75” height=“20” name=“Cife1” deviceid=“2” tooltip=“Cife 21”>
- <eventhandler>
  <ondrag event=“#system|print|c3: Drag started.” />
  <ondrop event=“#multibrowse|c3|view|$DATA$” id=“2” />
  </eventhandler>
- <popupmenu>
  <item text=“Execute command...” event=“#multibrowse|c3|prompt” />
  <separator />
  <item text=“Cancel” />
  </popupmenu>
  </panel>
  </graphicspanel>
  </content>
  </window>
- <window x=“325” y=“10” width=“300” height=“300” title=“Data Collections” visible=“yes”
name=“WINDOW_tree”>
- <menubar>
- <menu text=“File”>
  <item text=“Open XML file...” event=“#tree|TREE_main|open|[prompt|file]” />
  <separator />
  <item text=“Close” event=“#window|WINDOW_tree|close” />
  </menu>
  </menubar>
- <content>
- <scrollpane>
  <tree name=“TREE_main” file=“http://cife-32.stanford.edu:8080/room-applet/room.xml” />
- <!-- <tree name=“TREE_main” file=“http://fourd.stanford.edu/workspace/demo/room.xml”/>-->
  </scrollpane>
  </content>
  </window>
  <guiframe x=“10” y=“315” title=“GUI Frame” width=“620” height=“300” visible=“yes”
name=“GUIFRAME_guiframe” />
  <queryframe x=“630” y=“10” title=“Cife Query Frame” width=“400” height=“500” visible=“yes”
name=“GUIFRAME_guiframe2” server=“cife-20.stanford.edu:8080/exlnwsf/XlnWebServlet/test/files.XML” />
  </roomcontroller>
```

To visualize a scenario, one or more viewers and applications are launched and displayed on the large displays. For example, the 4D Modeler is running on the left board 601, MS Project is running on the center board 602, and the Room Controller is running on the right board 603. More than three SMART boards can be utilized. Using multiple screens provides more space for showing multiple views.

FIG. 8 is a screen snapshot showing the 4D Modeler plus the CIFE Time Controller 801. Moving the slider sends date events, which are received by the 4D Modeler and any other program listening for date events. In this way, the iRoom presents views that are synchronized automatically according to a common date. FIG. 9 is a screen snapshot of another exemplary time controller 901.

FIG. 10 is a screen snapshot of the three CIFE Data Viewers. The Table View on the left window 1001 lists construction activities. Building components are shown in the hierarchical Tree View in the bottom right window 1003. The activity, “R/I Ductwork-S1/3 Lvi 7,” was selected in the Table View and highlighted as highlight hl_1. This also causes the related building components to highlight in the Tree view, see, e.g., highlight hl_2. The top right window 1002 is the Document View, which is used to show Specification Items. If there had been a Specification Item that related to the selected activity, it would also be highlighted. This cross-highlighting is a key component of the CIFE iRoom necessary to establish focus among meeting attendees/participants.

FIG. 11 shows a portion of a MS Project® screen showing a Gantt chart view of the project.

The date line indicates the date under consideration. This line moves in response to Date Events, and the Activities highlight in response to a highlight activity event, see, e.g., highlight hl_3, as do the Data Viewers. The term “Gantt chart view” is known in the art and thus is not further described herein. MS Project and Excel listen for events using extensions written as Visual Basic macros.

Multiple copies of each viewer or application can be run to compare scenarios. Color-coding can be included in the scenario database to consistently color backgrounds and other markers for each scenario on the displayed windows. This makes it easier to identify and compare scenarios. FIG. 12 shows two scenarios being compared. The frames on the left have a different background color from the frames on the right. Also note that clicking on a view (upper right frame in FIG. 12) will change the virtual camera position, providing a different view of the 3D model. All active 4D Modelers respond to such an event.

The CIFE iRoom technology disclosed herein allows interactive display and manipulation of the same kinds of information from multiple disciplines that is currently displayed only on paper. The CIFE iRoom presents product, process and organization models and makes multidiscipline documents “live” on “electronic walls”. It also presents active synthesized table, tree views with data from multiple applications. Further, it includes tools for highlighting and comparing common items across multiple applications. It collects data dynamically and exchanges data across applications, making it easier for individual users and meeting participants to construct and compare different design and production scenarios, enabling “what if” discussions far beyond what are currently possible. Information shared at meetings is up-to-date, and there is computer record of the results of decision-making because changes can be applied immediately to design models. More importantly, the CIFE iRoom technology enables virtual design and construction (VDC), which supports a number of quantitatively measurable business objectives such as those listed in the domain models shown in FIG. 2. Realistically, an organization can effectively select a few as initial business objectives for use of VDC methods.

Schedule: The measurable project performance metric is the fraction of all scheduled design-construction activities that start (complete) within scheduled week. The short-term objective is 2-sigma (95% on-time performance). Industry practice is now commonly less than <0.5 sigma (<50%).

Cost: The measurable project performance metric is the budget performance as in current practice: by project, by week. The short-term objective is that 95% of budgeted items have final cost that is within 2% of budget price.

Decision latency (Decision-making promptness): The measurable project performance metric is the distribution of number of (working) days of waiting for information or a decision * number of people waiting. The short-term objective is a mean of one working day; 95% within two days.

Response latency (Decision-making no earlier than necessary): The measurable project performance metric is the distribution of number of (working) days that teams wait for response to decisions that have been made * number of people waiting. The short-term objective is mean working days less than one; 95% within two days. Lean manufacturing methods suggest this measurable objective.

Stakeholder participation: The measurable project performance metric is the fraction of desired (from point of view of owner, user, GC, major subs) stakeholders for planned design reviews that participate in project decisions. The short-term objective is greater than 90%.

Visualization appropriateness: The measurable project performance metric is the fraction of desired (from point of view of project stakeholders) project visualizations that are available interactively for review and analysis by stakeholders who participate in project review and meeting decision-making. The short-term objective is greater than 90%.

Prediction basis: The measurable project performance metric is the fraction of predictions that are founded on engineering analysis, vs. argumentation by stakeholders. The short-term objective is greater than 90%.

Design versions: The measurable project performance metric is the fraction of situations in which the project team seriously evaluates 2 or more significant alternative designs for each product system, construction process and organization design that accounts for greater than 10% of the project cost or time budget. The short-term objective is greater than or equal to 80%. Currently, projects often proceed after seriously evaluating fewer than one design alternative. That is, projects often commit to choices that some significant stakeholders do not understand well enough to critique effectively.

Meeting efficiency: The measurable project performance metric is the fraction of project meeting time devoted to explanation and evaluation (vs. description of the status, prediction of impact of choices). The short-term objective is greater than 75%.

Field-generated requests for information or change: The measurable project performance metric is the number of such requests. The objective is to eliminate them.

As discussed before with reference to FIG. 2, the data elements from these business objectives, stored in the data structures of the various applications, are mapped to a shared project data model. The relationships necessary to describe this mapping are modeled separate from the data themselves. This approach provides the flexibility towards different project scopes, defined by the applications and the data they provide to the miscellaneous project domains. So far, we have defined two types of relationships: First, the relationships between data objects in the applications and the shared iRoom project data model. Second, the relationships between objects of different types within the project data model itself. It is possible to implement further relationship types in the future, e.g., to represent specific semantic relationships like object hierarchies or priorities to modify values.

Below we describe a particularly useful enhancement to the CIFE iRoom embodiments above, hereinafter referred to as the CIFE iRoom XT embodiment. The CIFE iRoom XT allows other developers an easier and faster implementation of sophisticated extensions (XTensible) since it provides modularized software architecture with reusable class libraries.

The mapping to a shared project model taxonomy also provides a way to address the otherwise redundant data elements unambiguously. The programmer of cross application functions can solely focus on the objects of the project model. If the data elements in the applications have been mapped to their correspondent iRoom objects correctly, the modifications to iRoom objects will be reflected on their related data elements as well. The amount of data that has to be represented in the shared project data repository depends on the interactive functionality that should be provided. We have implemented a generalized highlighting functionality for any arbitrary model scope within the iRoom environment. We have discovered that for the highlighting functionality it is sufficient to store the unique data ID, assigned to the object within the respective applications, and an object name within the iRoom data repository. Our approach therefore led to a rather small project data repository. That is, only necessary information is stored in the shared repository, giving the project data model flexibility regarding the extension of the iRoom environment. Using this general data model we have developed a messaging framework that allowed us to provide interactive functionality across various applications connected to the environment. The software architecture and message format of one embodiment of the framework shown in FIG. 2 will be described below.

CIFE iRoom XTArchitectural Schema

To design a well structured and therefore easier to extend system upon the domain model described above, the development task has been broken up into three layers separated by functionality:
Application layer
Communication layer
Data storage layer

In this 3-tier architecture, the different AEC applications offer multiple GUIs to access the project data, while a Middleserver application controls the communication functionality that directs the messages between the different applications. Further the data that has to be shared among AEC applications is stored in a XML data file in order to enable the applications to communicate with another.

For a particular building component selected in ADT an iRoom specific extension of the ADT software called Heap Interface or Heapi generates a text message and pushes this message onto an event processor, which, in this case, is the Event Heap (eheap) developed by the Stanford University Computer Science Department. One skilled in the art would appreciate that the CIFE iRoom is not limited to any particular event handler and that it would be straightforward to integrate the CIFE iRoom with any appropriate interactive environment and with any suitable event handler.

In this embodiment, the EventHeap is a central software component located on one of the iRoom computers. Its purpose is to collect and store all messages for a predefined period of time. Any program on one of the iRoom devices can access these messages on the event heap using a so-called event heap “listener” application. This “listener” observes the event heap constantly and builds together with the Event Heap a communication infrastructure for miscellaneous message types. If the listener of an application is restricted to a specific message type, it is possible to address messages for particular applications.

Messages from applications are addressed to the Midserver and contain information to identify the selected building component in the ADT internal data model. Because the Event Heap is a largely passive system component and unable to distribute messages by sending them to the connected applications, the listener has to check the eHeap regularly for new messages addressed to the specific application it extends.

Like the other applications, the Midserver is connected to the iRoom with a listener, too. The

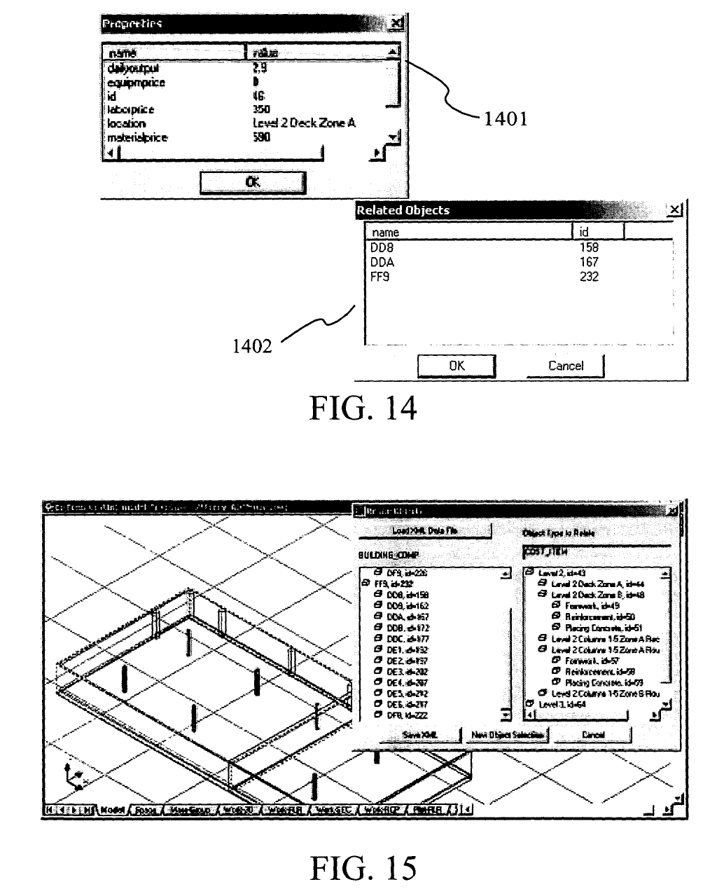

Midserver listener checks the eHeap for messages addressed to it and picks up the ADT message of our example to analyze and process its information. In the Midserver, the message is split up in its components. The first part of the message that is examined contains information about the action type that should be executed. In this example, the action type is “highlight (hl)”. Having information about the sending application and the ID of the selected element, the Midserver can then begin a query dialog with the iRoom data repository to find out, which data objects in other applications are related to the building component selected in ADT. Microsoft's XML Parser has been integrated to enable the Midserver to parse the XML data file according to the Document Object Model (DOM) standard known in the art. A detailed description of the dialog between the Midserver and the iRoom data model will be described in details with reference to FIGS. 13 and 14.

The result of this query dialog is generally a set of application IDs, object types and object IDs that can be reassembled to create another set of messages in the Heapi of the Midserver. When the Midserver Heapi puts these messages on the eHeap, they can again be picked up and interpreted by the listeners of the corresponding AEC applications and produce a reaction according to the algorithms defined by the action type.

Besides the basic Midserver functionality and the messaging infrastructure to establish interactivity between the separate applications, there are further components of the CIFE iRoom XT that can assist the user during the creation of the iRoom project data file. While there is already a Relation Tool that helps the user to create the relationships between iRoom objects in the XML data file, the data export into the iRoom is not yet possible from all of the AEC applications. So far, this functionality is only provided for ADT. If it should be able to use the iRoom for larger projects in the future, such data export components will have to be taken into consideration in order to allow a fast creation of an accordingly large project data file.

Messaging

In order to establish the Midserver as a central controlling instance for the communication between the applications, the message format had to be standardized throughout the iRoom.

Hence it is possible to extend the algorithms that analyze the content of the messages, at a central point in the system. Since we assume that the functionality and complexity of the iRoom will evolve over time, the possibility to extend or change the system easily will become more critical. One of the main advantages of the CIFE iRoom XT is the extensibility of its interactive functionalities that has been achieved through the changes to the message format.

While the original CIFE iRoom used eheap messages with a syntax like “ca=Pouring concrete Slab A3, Pouring concrete Slab A4” containing information about the object type, in this case Construction Activity, and their corresponding names in the applications “Pouring concrete Slab A3, Pouring concrete Slab A4”, there was a need for an extensible concept which offers the possibility for a more complex but also more flexible message format.

To achieve interactivity across the applications the syntax of the messages to the more complex domain model shown in FIG. 2, at least the following information has to be represented in the messages:
Sender Application ID
Receiving Application ID
Event type
Object ID

Using these parameters, the following format for messages in the CIFE iRoom XT has been derived:

```
    MIDSERVER_ID = action:hl_app:ADT_ID_elem:DD8
where  “MIDSERVER_ID” → Receiving application “database”;
    “action:hl” → Action type “highlighting”;
    “ADT_ID” → Sending application is ADT; and
    “elem:DD8” → Selected item id is “DD8”
```

The bundling of the communication makes the Midserver to the central receiver and sender of messages. However, with respect to the message format, the Midserver is treated within the communication environment the same way as all the other applications and therefore identified through an application ID. Table I shows defined parameter values for the message components created by the applications' Heap.

TABLE 1

| Message | | |
|---|---|---|
| Component | Values | Comment |
| Receiving | MIDSERVER_ID, ADT_ID, | COST and RESOURCE |
| Application | MSEXCEL_COST_ID, | address the two sheets |
| | MSEXCEL_RESOURCE_ID, | used in MS Excel for the |
| | MSPROJECT_ID, CPT_ID | according object types |
| Action Type | hl | the highlight event |
| Sending | MIDSERVER_ID, ADT_ID, | |
| Application | MSEXCEL_COST_ID, | |
| | MSEXCEL_RESOURCE_ID, | |
| | MSPROJECT_ID, CPT_ID | |
| Selected | Not predefined | The Heapi puts in the |
| Item | | element ID of the |
| | | selected or modified |
| | | data element |

Components

The following describes in details the functionalities and structure of the different components that have been built or adapted for the CIFE iRoom XT. Although the descriptions don't contain or explain the complete source code, they should ideally enable a developer to extend the functionality of the iRoom by helping to identify the respective sections in the system.

Application Interfaces “Listener” and “Heapi”

In order to connect an application with the CIFE iRoom, two functionalities have to be provided for each application: First, the listener has to be connected to the receiving application by a software interface that receives the messages and executes the respective commands in the application. Second, another algorithm has to be implemented in order to generate and send messages to the Midserver respectively to the iRoom. This functionality can be implemented either in the same software interface as for the listener connection or in a separate interface.

The answer to the question, which programming tools should be chosen to create these functionalities depends largely on the APIs provided by the particular application. While Microsoft's MS Project® and MS Excel® offer a popular API to access their internal data structure and their GUI elements via the predefined objects in Visual Basic (VB), the ADT can be accessed using its API for C++. For other applications, e.g., CPT's 4D CAD, Timberline's Precision Estimating, or SimVision®, that unfortunately don't provide a publicly accessible API, it is necessary to contact the developers and get access to the source code in order to find out how to execute the iRoom messages on the application internal data structure respectively in the GUI.

Using the Visual Basic for Application (VBA) API, the software interfaces to connect, e.g., MS Excel to the iRoom consist mainly of the following components:
Java-listener for the iRoom
Heapi-.EXE file
VBA macro file

The Java-listener is a component that already existed in the original CIFE iRoom. In order to work with the new message format, the Listener had to be adapted for each specific application to retrieve only messages with the respective new message prefix. As the message queue on the eHeap has to be checked regularly, the Listener has to run in a separate thread than the actual application. In this way the Listener is not blocking the application's general functionality. In order to access the within the VB Heapi implemented functionality, the Java-listener calls a compiled VB Heapi-.EXE file and hands over the message string as a file attribute.

Within the Heapi, the message string is analyzed for the action type that should be executed. In the case of MS Excel, it is further necessary to analyze to which worksheet the message addresses, since in our test cases Excel was used to manage a worksheet with the cost table and another with a table for the resources. The following step is then to extract the application internal ID(s) and to call the functions like highlighting etc. to be displayed in the application's GUI.

If the respective application should be enabled to send messages, there has to be another algorithm that generates these CIFE iRoom XT messages. For the two MS Offices applications, for example, a VBA macro is provided that creates a highlighting message addressed to the Midserver and containing the ID of an object selected by the user within the respective Office application.

Another possibility to connect an application to the iRoom is to use a C++API. In the case of ADT, the functionality to create highlighting messages for the Midserver has been written using C++ dynamic link library files (.dll files). These .dll files have to be loaded at the start of the respective application in order to enable the desired Heapi functionality.

Midserver

The Midserver has to fulfill three main tasks in the iRoom environment:
1. Receive incoming messages from the applications;
2. Process the messages and identify the relations according to the underlying XML project data file; and
3. Generate the outgoing messages to the respective applications.

Furthermore, the Midserver GUI offers menu entries to select a specific XML project data file and to choose the eHeap server to which the applications should listen. To understand how the Midserver and therefore the communication in the CIFE iRoom XT works, it is necessary to understand the parsing process that has to be executed every time an incoming message is processed. This parsing mechanism also shows, how flexible the chosen solution is towards different scopes in iRoom sessions, towards different data contents and levels of detail in the XML project data files.

Whenever a message from an application to the Midserver is retrieved by its listener, the message string has to be analyzed. The first information that the Midserver extracts from the string is the action type it has to execute. This parameter defines the algorithms that will be used for the respective project element. So far, only one action type: the highlighting is implemented. Furthermore, information to identify the selected elements in the application respectively their corresponding objects in the iRoom project data file has to be extracted from the message. The Midserver therefore uses the “sending application” parameter and the “element id” from the message string to parse the XML file for the corresponding iRoom objects. The required relationships between these data elements are modeled as RELATION elements in the RELATIONSET_IDMAPPING XML elements. Taking the message example with ADT as the sending application, the steps to parse the data file are as follows:

First, the Midserver has to identify all RELATIONEST_IDMAPPING elements in the iRoom data file, which map objects of type ADT_ID, to their corresponding objects in the iRoom framework. A code example for such an XML element is given below. In this example, ADT objects (ADT_ID) are assigned to iRoom objects (IROOM_ID) of type BUILDING_COMP. While the RELATIONSET element describes the relation type, the specific assignments between actual data elements are defined by RELATION elements. In the data file schema, RELATION elements are child elements of the complex RELATIONSETs.

Then, the RELATIONs in the respective RELATIONSET elements have to be parsed for objects with the ADT element name “DD8”. In the code example below, the element name “DD8” can be found in the second RELATION element, where it is assigned to the iRoom object with the IROOM_ID “158”.

<RELATIONSET_IDMAPPING id=“156” object1=“IROOM_ID”
object2=“ADT_ID” objecttype=“BUILDING_COMP”>
<RELATION id=“157” object1=“153” object2=“DD7” />
<RELATION id=“161” object1=“158” object2=“DD8” />
<RELATION id=“166” object1=“162” object2=“DD9” />
<RELATION id=“171” object1=“167” object2=“DDA” />
<RELATION id=“176” object1=“172” object2=“DDB” />
<RELATION id=“181” object1=“177” object2=“DDC” />
. . .
</RELATIONSET_IDMAPPING>

Summarizing the parsing of the RELATIONSET element above, the Midserver retrieves the following information from the project data file:
ADT contributes data elements of the type building components (BUILDING_COMP) to the project model
The application ID “DD8” corresponds to the XML element in the data file with the IROOM_ID “158”.

Since the actual application ID and the iRoom object type are merely predefined values of XML attributes, the iRoom domain framework can easily be extended with other applications or objects without having to change the parsing algorithms.

In the second step of the parsing algorithm all objects of other types within the XML data repository that are related to the selected one have to be found. The relations between objects of the iRoom are described by another XML element type with the name RELATIONSET_IROOMDB. These XML elements are further queried for relationsets with objects of the type BUILDING_COMP. Since objects of the type building components are normally related to a number of different object types, e.g. to construction activities and also to cost items etc., this query generally returns a couple of relationsets. To keep our example simple, we assume that the parser finds just one relationset with building components and construction activities. In this case, it retrieves a relation between the building component 158 and the construction activity 6.

<RELATIONSET_IROOMDB id=“321” object1=“BUILDING_COMP”
object2=“CONST_ACT”>
<RELATION id=“325” idobject1=“226” idobject2=“33” />
<RELATION id=“326” idobject1=“158” idobject2=“6” />
<RELATION id=“327” idobject1=“162” idobject2=“19” />
. . .
</RELATIONSET_IROOMDB>

After the parser has identified the type and ID of all iRoom objects that are related to the data element specified in the message, the Midserver has to map these internal ID's to their correspondent elements in the respective applications. Once more, the RELATIONSET_IDMAPPING elements have to be parsed to achieve this. In the code example shown below, the iRoom object construction activity “6” is assigned to the corresponding application “MSProject_ID” and further to the MS Project internal ID “9”.

<RELATIONSET_IDMAPPING id=“265” object1=“IROOM_ID”
object2=“MSPROJECT_ID”
objecttype=“CONST_ACT”>
<RELATION id=“266” idobject1=“4” idobject2=“1” />
<RELATION id=“267” idobject1=“5” idobject2=“2” />
<RELATION id=“268” idobject1=“6” idobject2=“3” />
<RELATION id=“269” idobject1=“7” idobject2=“4” />
<RELATION id=“270” idobject1=“8” idobject2=“5” />
<RELATION id=“271” idobject1=“9” idobject2=“6” />
<RELATION id=“272” idobject1=“10” idobject2=“7” />
. . .
</RELATIONSET_IDMAPPING>

With this information the Midserver can create outgoing messages to the different applications. We decided to bundle elements for the same application within one message. If more than one element in an application is addressed, the parser is programmed to row the IDs of these elements in the message separated by commas in the form of:
MS_Project_ID=action:hl_app:MIDSERVER_ID_elem:6,7,8

After the Midserver has sent the messages to the eheap, they can be picked up by the listeners and finally be processed by the respective application's Heapi.

Project Data Repository

The project data repository is a shared XML data file in the CIFE iRoom environment that stores the required data in order to allow interactivity between the different applications. It contains information about the shared data objects of the involved applications and the relations between these objects. This information enables the Midserver to provide interactive functionalities.

This shared data repository provides advantages pertaining to the extensibility and flexibility of the iRoom environment. The main characteristics are:
object oriented structure,
organization in domains,
consistent data structure,
compatibility to former iRoom objects.

The repository contains object-oriented structures that represent the corresponding data elements in the applications. On the “_MODEL” level in the data structure shown in FIG. 5B, the data is organized in different project domains named after the disciplines such as Design, Schedule etc. The objects of one data model can be reused for another data model. The present data model includes new objects for design, cost and resource data. On the object level, the present data model is redundancy free. That is, a specific type of XML element only occurs at a specific position in the structure of the project data file. This allows a much easier maintenance of the project data repository itself and also of the iRoom software components described herein.

In the data model shown in FIG. 5B, objects are defined “optional” by default. This provides flexibility to customize the iRoom data to the current scope. As mentioned above, the object structure can be extended by other objects, e.g., Documents, Specs, Materials, or Participants. Of course, these new objects will have to be related to respective data elements in the applications using RELATIONSET_IDMAPPING elements in order to enable the Midserver to access them. Further, we have created a Document Type Definition (DTD) file with the name iRoomXT.dtd. This file defines the attributes of the data objects and their occurrence and can be used by the parser to provide an automated validation check of the project data file before it is used with the Midserver. Future extensions of the iRoom data model will have to be reflected in this DTD, too.

A significant improvement of the CIFE iRoom XT is the explicit modeling of relations between data objects. This allows not only an easier maintenance of the modeled relations between data elements, but also offers an easy possibility to extend the relation model with other relation types. Currently, two relation-types are used in the data file: One to model the relationships between data elements within the applications and their corresponding objects of the iRoom framework in the shared XML data repository and another one to model the internal relationships between the objects within the data repository of the iRoom.

Relationships between data elements in the applications and their correspondent iRoom repository objects are generally of the type n:l, since generally the shared iRoom representation of the data is not more detailed than its original data model. Therefore, an object in the iRoom data repository represents one or more data elements in an application, dependent on the required level of detail for the XML data used within iRoom meetings. The XML element used to model such relationships is RELATIONSET_IDMAPPING. In this element, the value “IROOM_ID” for the attribute object1 is fixed in order to accelerate the parsing process described above. Relationships between the objects in the iRoom data repository are generally of type n:m. For example, a building component can be related to many construction activities as well as the other way round. These iRoom internal relationships are modeled in the element RELATIONSET_IROOMDB.

Relation Tool

It is not an easy task to generate the relationships between objects in the shared iRoom data file. For large projects, the number of different objects that have to be linked can easily reach more than one thousand. Thus, to be able to use the iRoom efficiently, the implementation of a software component with an adequate user interface is extremely important.

Our approach to develop a relation tool with a GUI that allows the relation of objects of two different objects types is shown in FIG. 13. The screenshot shows a dialog window with two tree view controls that have been implemented using the Microsoft Foundation Classes (MFC) library. MFC tree view controls allow the representation of hierarchies between objects, a feature that makes the navigation and especially the relation of object groups much easier than using plain object lists without any hierarchical structures. The objects are represented in the tree views by their element name and their unique ID. Both attributes are obtained from the XML data elements in the iRoom data file.

The MFC further allowed the implementation of right click context menus for the objects in the tree controls. Thus the user can access more detailed information about the objects than just their name, e.g. using the “Properties” entry within the context menu pops up a window 1401 showing all attributes of the iRoom object (FIG. 14 left). A second menu entry “Related objects” displays in window 1402 the objects that have already been related to the selected one (FIG. 14 right).

Using the Relation Tool, the first step is to load the respective XML data file into the application using the “Load XML data file” button that invokes a standard Microsoft Windows file select dialog. Further, the object types to relate can then be entered in the two input fields above the tree controls. The relations between two objects of the trees can now be established by simply dragging one object of one tree over the correspondent object of the other tree while holding down the left mouse button. The Relation Tool automatically creates the relation upon the left mouse button being released.

After the relations between two object types have been created, they can be saved within the respective iRoom file by clicking the “Save XML” button in the dialog window. New object types can be selected by pressing the “New Object Selection” button without having to start the tool again. The “Cancel” button can be used to exit the dialog without saving the created or altered relations to the data file. Like the Midserver, the Relation Tool uses Microsoft's XML Parser to access the XML file and to parse the data.

The Relation Tool itself has been programmed as a stand-alone application that can be used to efficiently relate all object types of the iRoom data repository. This version of the Relation Tool can be started by executing RelateObjects.exe. There is also a second version that has been integrated in AutoDesk's Architectural Desktop (ADT). The Relation Tool version implemented in the ADT is restricted to the Building Components for Object Type One. It nevertheless offers more features than the version for general relations described above. Since the Relation Tool is running within the ADT environment, a highlighting functionality for the structural elements and zones that are selected in the tree control could be implemented by using ADT's Object Modeling Framework (OMF) API. Hence the user receives information about the position of the specific building component in the geometrical model in a comfortable way. To start the ADT Relation Tool, the .dll-file extension “relateInADT.arx” has to be uploaded into the ADT. The Relation Tool itself can be started with the ADT command line command “relateObj” that invokes a dialog similar to the one illustrated in FIG. 15.

It will be straightforward for one skilled in the art to integrate new applications into the CIFE iRoom XT framework. For “How-To” examples, readers are directed to the CIFE Technical Report #144, Stanford University, December 2002.

To summarize, the CIFE iRoom framework provides the following advantages:
separates a model from its view and from its control,
enables visualization of relationships across different views of a single model, and
provides convenient review and compare alternative states of a model simultaneously.

These advantages are made possible by the following three core software components:
1. CIFE iRoom Scenario Database.
2. Information Viewers.
3. Room Controller.

One of the many advantages of the present invention is that it provides a new approach in which related data or commonalities between different sources (such as software applications and/or devices that are heterogeneously organized) can be synchronized and/or simultaneously displayed on computer screens, displays, electronic walls, smart-boards, or any suitable interactive display means. This is accomplished primarily by the separation of the user interface control from the application into an additional control and further by the design of a database that holds related data, which is shared by multiple independent databases and thus is both effective and highly parsimonious. The database involves only small amounts of data, which becomes a very efficient way to run and control the views in different applications. In other words, the design of a project database that holds only data shared by multiple independent databases and is both effective and highly parsimonious.

Many technical fields could use the innovative approach disclosed herein. The present invention is particularly useful in the presentation or review of engineering, manufacturing or management projects that are data-rich and/or contain complex data structures, flow diagram or complex models. The multi-display environment is extremely helpful to describe and make predictions about realistic project scenarios, and to analyze model content and evaluate design alternatives. Further, virtual design and construction methods and iRoom technology together allow project teams to attempt to meet specific project objectives. Future technology will dramatically drop the cost of the display technology (now about $10K for three large touch sensitive panels), further facilitates the affordability and practicality of the iRoom technology.

Although the present invention and its advantages have been described in detail, it should be understood that the present invention is not limited to or defined by what is shown or described herein. As one of ordinary skill in the art will appreciate, various changes, substitutions, and alterations could be made or otherwise implemented without departing from the principles of the present invention. Accordingly, the scope of the present invention should be determined by the following claims and their legal equivalents.

1. An Internet-enabled infrastructure useful for visualizing relationships across different views of a single project, said infrastructure comprising:
a scenario database for storing common data for multiple scenarios of said single project;
information viewer means for displaying and manipulating said common data; and
a universal controller means for enabling one or more users to dynamically managing said information viewers means and different applications across application domains and physical boundaries, said different applications are simultaneously visible, linked, and usable by said one or more users.

2. The infrastructure according to claim 1, wherein
said scenario database is characterized as an eXtensible Markup Language (XML) database and wherein
each of said scenarios is represented as an XML file.

3. The infrastructure according to claim 1, further comprising:
different scenarios of said single project residing simultaneously in said scenario database.

4. The infrastructure according to claim 3, wherein
each of said different scenarios is driven by one of said different applications.

5. The infrastructure according to claim 1, wherein
said information viewer means are capable of
extracting said common data from said different applications,
selectively aggregating said common data,
generating multiple information views of said common data, and
highlighting said multiple information views simultaneously across said application domains and physical boundaries.

6. The infrastructure according to claim 5, wherein
said multiple information views comprise table view, tree view, and document view of said common data.

7. The infrastructure according to claim 5, further comprising:
a synchronizing means for synchronizing said multiple information views.

8. The infrastructure according to claim 6, wherein
said synchronizing means is characterized as a time controller for synchronizing said multiple information views to a common time.

9. The infrastructure according to claim 6, wherein
said synchronizing means is characterized as a date slider for synchronizing said multiple information views to a common date.

10. The infrastructure according to claim 6, wherein
said synchronizing means synchronizes said multiple information views to a commonality of said single project.

11. The infrastructure according to claim 1, wherein
said universal controller means enables said one or more users to manage a plurality of devices operatively distributed in said infrastructure.

12. The infrastructure according to claim 1, wherein
said universal controller means enables said one or more users to select content from said scenario database.

13. The infrastructure according to claim 1, further comprising:
two or more electronic display means, wherein
said information viewer means, said different applications, and said universal controller means are simultaneously visible, linked, and usable by said one or more users via said two or more electronic interactive display means.

14. The infrastructure according to claim 13, wherein
said two or more electronic display means are characterized as World Wide Web Consortium (W3C) compliant multimodal interaction means.

15. A computer product comprising a computer readable medium carrying computer-executable instructions for providing:
information viewer means capable of
extracting from multiple different sources data related to a single project,
selectively aggregating said related data,
generating multiple information views of said related data, and
highlighting said multiple information views simultaneously across application domains and physical boundaries.

16. The computer product of claim 15, wherein
said multiple information views comprise table view, tree view, and document view of said related data.

17. A computer product comprising a computer readable medium carrying computer-executable instructions for providing:
an interactive graphical user interface for enabling one or more users to dynamically controlling multiple information views and multiple distributed applications across application domains and physical boundaries, said multiple information views and said multiple distributed applications are simultaneously visible, linked, and usable by said one or more users.

18. The computer product of claim 17, wherein
said interactive graphical user interface further enables said one or more users to manage a plurality of devices and to select content from a scenario database.

19. A system having at least one server, a plurality of clients, a plurality of devices including two or more interactive display means, and an event processor residing in said at least one server for processing events submitted to a shared data space in said system, wherein said two or more interactive display means are simultaneously visible, linked, and usable by one or more users, the improvement comprising:
a scenario database for storing common data for multiple scenarios generated by said one or more users via various different applications operatively distributed in said system;
information viewers for displaying and manipulating said common data; and
a universal controller for enabling one or more users to dynamically managing said information viewers and said various different applications across application domains and physical boundaries.

20. The improvement according to claim 19, wherein
said multiple scenarios relate to a project or model.

21. The improvement according to claim 20, wherein
said project is characterized as a multidisciplinary construction project.

22. The improvement according to claim 20, wherein
said model is characterized as a virtual design and construction model.

23. The improvement according to claim 20, wherein
said model is characterized as a four dimensional project model.

24. The improvement according to claim 19, wherein
said events include date events, view events, and component events; and wherein
said information viewers and said universal controller are capable of listening for and acting on said events submitted to said shared data space.

25. The improvement according to claim 19, wherein
said information viewers are capable of
extracting said common data from said various different applications,
selectively aggregating said common data,
generating multiple views of said common data, and
highlighting simultaneously said multiple views across said application domains and physical boundaries.

26. The improvement according to claim 25, wherein
said multiple views comprise table view, tree view, and document view.

27. The improvement according to claim 26, wherein
said multiple scenarios relate to a multidisciplinary construction project; and wherein
said table view displays details of construction activities and building components of said multidisciplinary construction project in a table format, said tree view displays details of said construction activities and said building components of said multidisciplinary construction project in a tree format, and said document view displays details of specification items of said multidisciplinary construction project in a document format.

28. The improvement according to claim 25, further comprising:
a synchronizing means for synchronizing said multiple views.

29. The improvement according to claim 27, wherein
said synchronizing means is characterized as a time controller for synchronizing said multiple views to a common time.

30. The improvement according to claim 27, wherein
said synchronizing means is characterized as a date slider for synchronizing said multiple views to a common date.

31. The improvement according to claim 27, wherein
said synchronizing means synchronizes said multiple views to a commonality.

32. The improvement according to claim 19, wherein
said universal controller further enables said one or more users to manage said plurality of devices simultaneously.

33. The improvement according to claim 31, wherein
said plurality of clients reside in a collection of machines selected from the group consisting of desktop computers, laptops, network-enabled devices, and personal digital assistant (PDA) devices.

34. The improvement according to claim 19, wherein
said universal controller further enables said one or more users to select content from said scenario database.

35. The improvement according to claim 19, wherein
said two or more interactive display means are characterized as World Wide Web Consortium (W3C) compliant multimodal interaction means.

36. The improvement according to claim 19, wherein
said various different applications include a four dimensional modeling application, a project management application, and a spreadsheet application, each of which is capable of sending and receiving said events.

37. The improvement according to claim 19, further comprising:
a communication server for directing messages between said various different applications.

38. The improvement according to claim 37, wherein
said messages include a sender application identifier, a receiver application identifier, an event type indicator, and an object identifier.

39. The improvement according to claim 37, wherein
said communication server is capable of
receiving incoming messages from said various different applications;
processing said incoming messages and identifying relations in said incoming messages;
generating outgoing messages; and
sending said outgoing messages to said shared data space.
